(19) United States
(12) Patent Application Publication
(10) Pub. No.: US 2026/0253782 A1
(43) Pub. Date: Aug. 27, 2026

(54) COIL DEVICE

(71) Applicant: TDK Corporation, Tokyo (JP)

(72) Inventors: Yuichi OYANAGI, Tokyo (JP); Toru TONOGAI, Tokyo (JP)

(73) Assignee: TDK Corporation, Tokyo (JP)

(21) Appl. No.: 19/545,428

(22) Filed: Feb. 20, 2026

(30) Foreign Application Priority Data
Feb. 25, 2025 (JP) 2025-028326

(51) Int. Cl. H01F 27/255; H01F 27/28

(52) U.S. Cl. CPC H01F 27/255; H01F 27/2847

(57) ABSTRACT

A coil device includes a core including magnetic particles and a winding portion including a rectangular wire wound edgewise. A space continuing inward from an outer side of the winding portion is provided between adjacent turns of the rectangular wire along a winding axis of the winding portion in a section of the core. Some of the magnetic particles included in the core are in the space.

The present application claims a priority to Japanese patent application No. 2025-028326 filed on February 25, 2025, which is incorporated herein by reference in its entirety.

### BACKGROUND

The present disclosure relates to a coil device.

Known as a coil device used as an inductor or the like is a coil device in which an air core coil of an edgewise wound rectangular wire is embedded in a core (Patent Document 1). Such a coil device, despite having a small volume, can be expected to have a high inductance.

However, because a core of such a coil device is pressure-molded using a magnetic body powder, this pressure may cause a short circuit between adjacent turns of a rectangular wire of a winding portion.

Patent Document 1: JP Patent Application Laid Open No. 2004-311756

### SUMMARY

A coil device according to one aspect of the present disclosure includes

a core including magnetic particles, and

a winding portion including a rectangular wire wound edgewise,

wherein

the magnetic particles include insulation coated metal magnetic particles including a metal magnetic body covered with an insulating film,

a space continuing inward from an outer side of the winding portion is provided between adjacent turns of the rectangular wire along a winding axis of the winding portion in a section of the core, and

some of the magnetic particles included in the core are in the space.

### BRIEF DESCRIPTION OF THE DRAWING(S)

FIG. 1 is a perspective view of a coil device according to one embodiment.

FIG. 2 is a perspective view of the coil device shown in FIG. 1 viewed from a mounting surface side.

FIG. 3 is a sectional view of the coil device shown in FIG. 1 along a line III-III.

FIG. 4 is an enlarged view of a structure of a wire shown in FIG. 3.

FIG. 5 is an enlarged view of a space between turns of the wire shown in FIG. 3.

FIG. 6 is an enlarged view of a structure of a magnetic particle shown in FIG. 5.

### DETAILED DESCRIPTION

Hereinafter, an embodiment of the present disclosure is described with reference to the drawings. Illustrations in the drawings are only schematically and exemplarily provided for understanding of the present disclosure; and the illustrated appearance, dimensional ratios, or the like may not be exactly the same as those of an actual device. The present disclosure is not limited to the following embodiment.

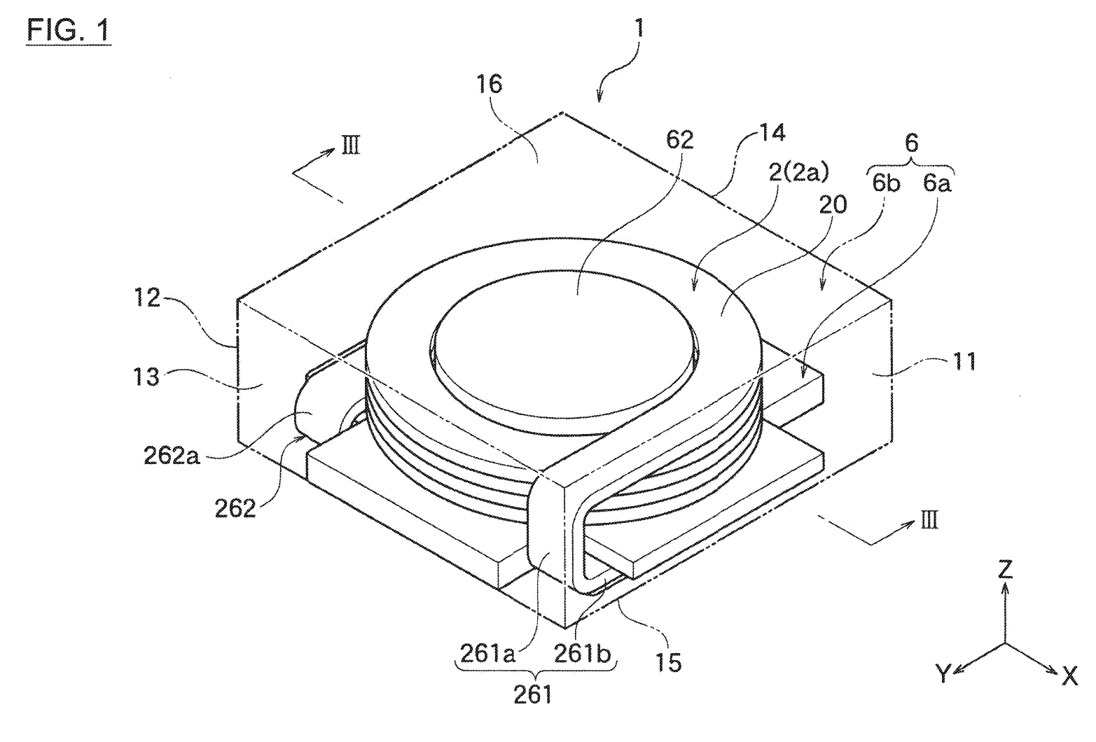

A coil device 1 of the present embodiment shown in FIG. 1 is a surface mounting type inductor and may be mounted on, for example, a power supply circuit of electronics. The coil device 1 may have any dimensions. The coil device 1 has, for example, a width of 1.0 to 7.0 mm in the X-axis direction, a length of 1.0 to 7.0 mm in the Y-axis direction, and a height of 0.5 to 5.0 mm in the Z-axis direction.

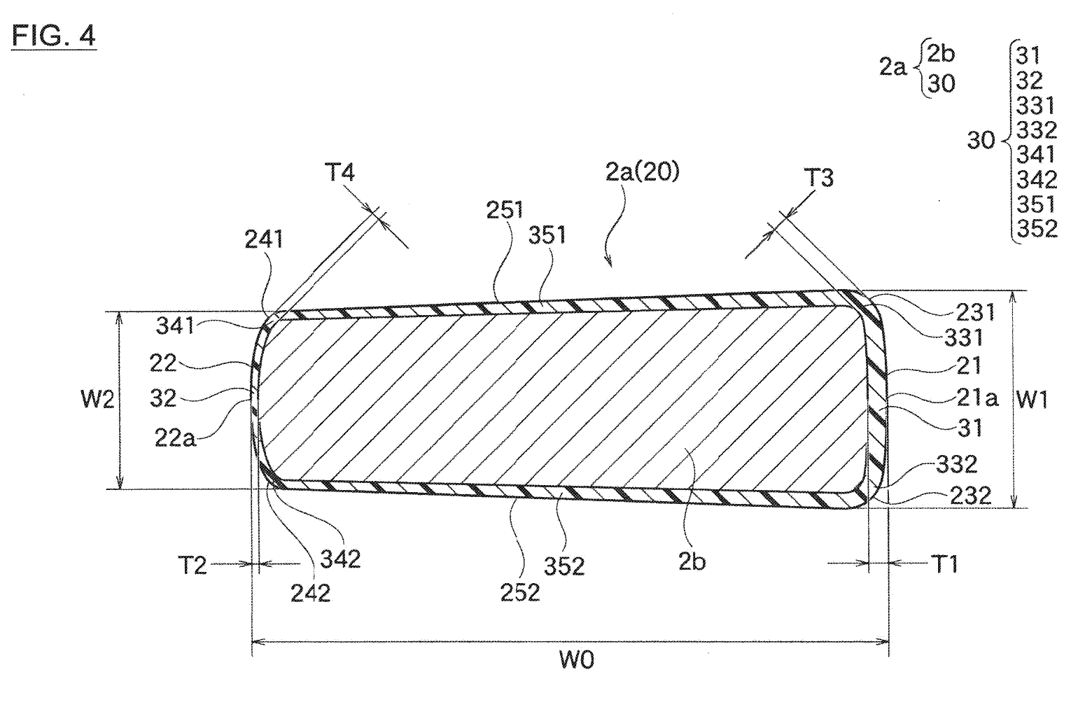

As shown in FIG. 1, the coil device 1 includes a coil 2, which is composed of a rectangular wire 2a having a surface covered with an insulating layer 30 (see FIG. 4), and a core 6, which has magnetism. In the coil device 1, at least a winding portion 20 of the coil 2 is embedded in the core 6.

The coil device 1 may have any shape. In the example shown in FIG. 1, the coil device 1 has a substantially rectangular parallelepiped shape and includes a first outer surface 11, a second outer surface 12, a third outer surface 13, a fourth outer surface 14, a fifth outer surface 15, and a sixth outer surface 16. The first outer surface 11 and the second outer surface 12 face each other in a first direction. The third outer surface 13 and the fourth outer surface 14 face each other in a second direction. The fifth outer surface 15 and the sixth outer surface 16 face each other in a third direction. The first direction, the second direction, and the third direction are orthogonal to each other.

In the drawings, the X-axis is an axis corresponding to the first direction; the Y-axis is an axis corresponding to the second direction; and the Z-axis is an axis corresponding to the third direction. The origin of the XYZ coordinate system is designated as a center of the core 6. The external shape of the coil device 1 is not limited to the substantially rectangular parallelepiped shape and may be other polyhedral shapes, such as an octahedral shape and a decahedral shape.

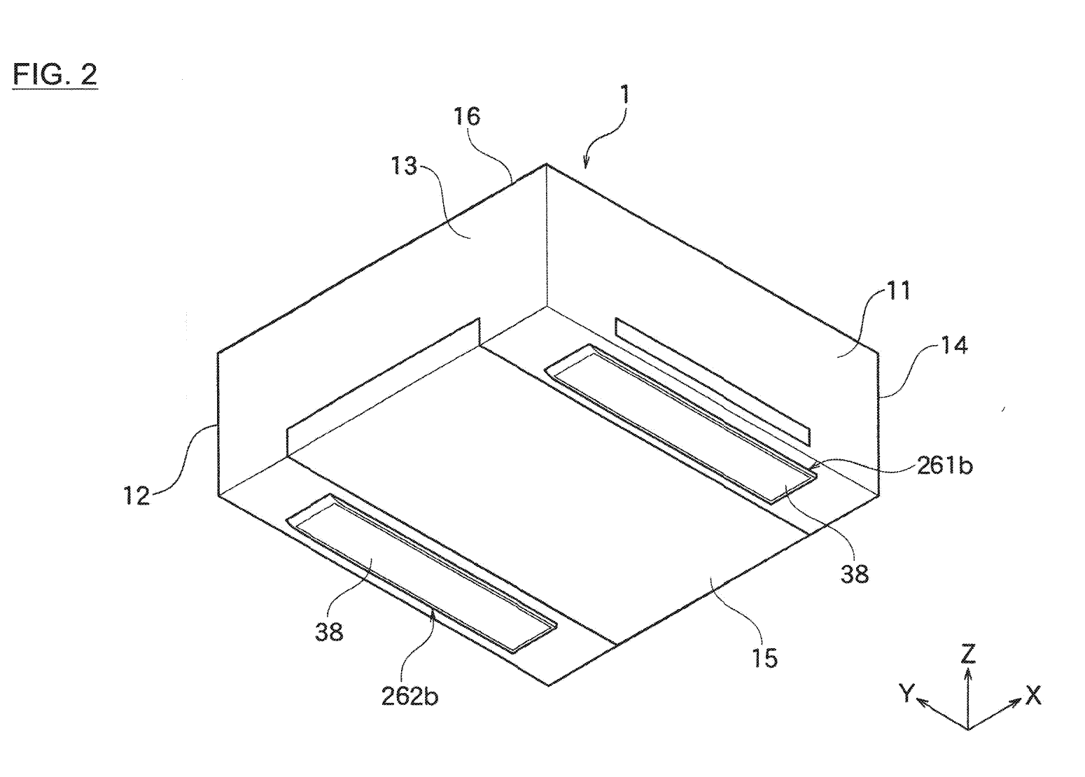

As shown in FIG. 1, the coil 2 is composed of the rectangular wire 2a and includes the winding portion 20, where the rectangular wire 2a is edgewise wound. The winding portion 20 is embedded in the core 6. The coil 2 further includes a pair of lead-out portions 261 and 262 drawn out from the winding portion 20. The lead-out portion 261 constitutes one end of the coil 2. The lead-out portion 262 constitutes an other end of the coil 2. As shown in FIG. 2, the lead-out portions 261 and 262 are partly exposed from the bottom surface (fifth outer surface 15) of the core 6.

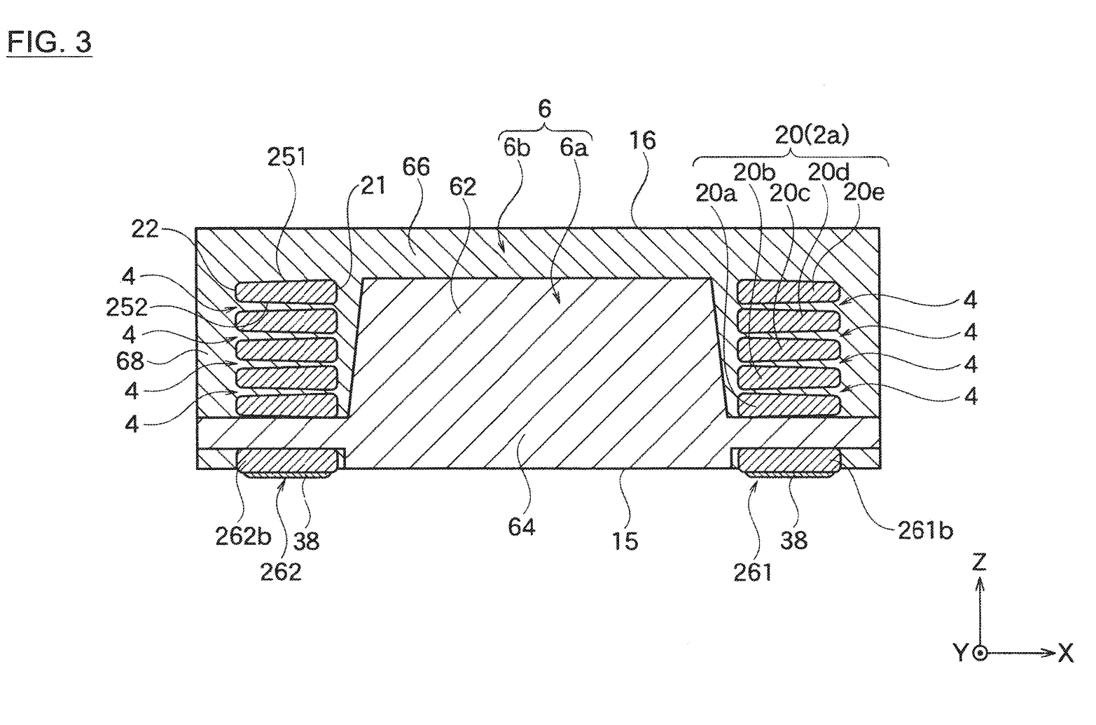

FIG. 3 is a sectional view perpendicular to the Y-axis of the coil device 1. As shown in FIG. 3, the winding portion 20 is formed by winding the rectangular wire 2a edgewise by five turns and includes turn layers 20a to 20e. The turn layers 20a to 20e are overlappingly disposed in the Z-axis direction. However, the number of turns of the winding portion 20 is not limited provided that the winding portion 20 has at least two turns, i.e., the number of turn layers is two or more. Between the turn layers 20a to 20e is a space 4. The core 6 is partly in this space 4.

FIG. 4 is an enlarged view of the rectangular wire 2a of the winding portion 20 (each turn layer) shown in FIG. 3. As shown in FIG. 4, the rectangular wire 2a is composed of a wire whose surface is covered with the insulating layer 30. A conductor 2b constituting the rectangular wire 2a may be of any material. Copper, silver, an alloy containing these metals, or other metal or alloy is used. The insulating layer 30 is not limited. A known insulating film, such as a polyamide-imide resin, a polyurethane resin, or an epoxy acrylic resin, is used.

The rectangular wire 2a shown in FIG. 4 may have any width W0. The width W0 is, for example, 0.1 to 0.7 mm. Its thickness in the Z-axis direction is, for example, 0.05 to 0.5 mm. The rectangular wire 2a of the winding portion 20 includes an inner end 21 close to the winding axis and an outer end 22 far from the winding axis. In a cross section of the rectangular wire 2a of the winding portion 20, a thickness W1 of the inner end 21 is larger than a thickness W2 of the outer end 22. That is, the rectangular wire 2a has a substantially trapezoidal cross-sectional shape with a longer inner side and a shorter outer side. In the present specification, a cross section of the rectangular wire refers to a section perpendicular to a direction in which the rectangular wire extends. In the present embodiment, because the rectangular wire 2a of the winding portion 20 extends substantially on an XY plane, a cross section of the rectangular wire 2a refers to a section extending along the Z-axis direction. In FIG. 4, this cross section of the rectangular wire 2a is a section extending along the Z-axis and the X-axis. In the present embodiment, characteristics of a cross section of the rectangular wire 2a of the winding portion 20 are common to any cross sections of the winding portion 20.

As shown in FIG. 4, at the winding portion 20, the insulating layer 30 entirely covers the conductor 2b along a circumferential direction of the rectangular wire 2a. The insulating layer 30 may have any thickness. The thickness may be, for example, 1/50 to 1/10 of the thickness of the rectangular wire 2a in the Z-axis direction.

As shown in FIG. 4, the insulating layer 30 at the inner end 21 of the rectangular wire 2a includes an inner end portion 31 having a thickness T1 whereas the insulating layer 30 at the outer end 22 of the rectangular wire 2a includes an outer end portion 32 having a thickness T2. The thickness T1 is larger than the thickness T2. That the thickness T1 of the inner end portion 31 of the insulating layer 30 being larger than the thickness T2 of the outer end portion 32 of the insulating layer 30 in this manner enables a short circuit to be prevented, because possible damage to the inner end 21 close to the winding axis of the winding portion is less likely to reach the conductor 2b. In contrast, because the outer end 22 is less likely to have damage that leads to a short circuit, a smaller thickness of the insulating layer at the outer end 22 than at the inner end 21 can sufficiently prevent a short circuit.

The inner end portion 31 of the insulating layer 30 is a region including an innermost end 21a, closest to the winding axis, of the rectangular wire 2a. The inner end portion 31 connects inner corner portions 331 and 332 of the insulating layer 30. The inner corner portions 331 and 332 constitute inner corners 231 and 232 of the rectangular wire 2a described later. The thickness T1 may be even at the inner end portion 31 but may be partially smaller or larger. In the present embodiment, the thickness T1 of the inner end portion 31 of the insulating layer 30 is largest at the innermost end 21a. This thickness, at the innermost end 21a, of the inner end portion 31 can be deemed to be the thickness T1 of the inner end portion 31 of the insulating layer 30.

The outer end portion 32 of the insulating layer 30 is a region including an outermost end 22a, farthest from the winding axis, of the rectangular wire 2a. The outer end portion 32 connects outer corner portions 341 and 342 of the insulating layer 30. The outer corner portions 341 and 342 constitute outer corners 241 and 242 of the rectangular wire 2a described later. The thickness T2 may be even at the outer end portion 32 but may be partially smaller or larger. In the present embodiment, the thickness T2 of the outer end portion 32 of the insulating layer 30 is largest at the outermost end 22a. This thickness, at the outermost end 22a, of the outer end portion 32 can be deemed to be the thickness T2 of the outer end portion 32 of the insulating layer 30.

The thickness T1 of the inner end portion 31 of the insulating layer 30 and the thickness T2 of the outer end portion 32 of the insulating layer 30 are not limited. The thickness T1 of the inner end portion 31 of the insulating layer 30 may be, for example, 1.2 to 3 times the thickness T2 of the outer end portion 32 of the insulating layer 30.

As shown in FIG. 4, the inner corner portions 331 and 332 of the insulating layer 30, which constitute the inner corners 231 and 232 of the rectangular wire 2a, have a thickness T3 whereas the outer corner portions 341 and 342 of the insulating layer 30, which constitute the outer corners 241 and 242 of the rectangular wire 2a, have a thickness T4. The thickness T3 may be larger than the thickness T4. The thickness T3 of the inner corner portion 33 of the insulating layer 30 may be, for example, 1.2 to 3 times the thickness T4 of the outer corner portion 34 of the insulating layer 30. In the present specification, corners of the rectangular wire refer to vertices of a quadrilateral that is inscribed within an outer circumferential surface of the rectangular wire and has a largest possible area in a cross section of the rectangular wire. In the present embodiment, among the vertices of a largest quadrilateral inscribed within the outer circumferential surface of the rectangular wire 2a, two vertices close to the winding axis are referred to as the inner corners 231 and 232 whereas the other two vertices far from the winding axis are referred to as the outer corners 241 and 242. The inner corners 231 and 232 are hereinafter referred to as inner corner 23. The inner corner portions 331 and 332 of the insulating layer 30 are referred to as inner corner portion 33. The outer corners 241 and 242 are referred to as outer corner 24. The outer corner portions 341 and 342 are referred to as outer corner portion 34.

Between the inner corner 231 and the outer corner 241 of the rectangular wire 2a is an intermediate portion 251. An intermediate part 351 of the insulating layer 30 is located at the intermediate portion 251. The intermediate part 351 may become thicker from the outer corner portion 341 to the inner corner portion 331. Between the inner corner 232 and the outer corner 242 of the rectangular wire 2a is an intermediate portion 252. An intermediate part 352 of the insulating layer 30 is located at the intermediate portion 252. The intermediate part 352 may become thicker from the outer corner portion 342 to the inner corner portion 332. The intermediate portions 251 and 252 are hereinafter referred to as intermediate portion 25. The intermediate parts 351 and 352 of the insulating layer 30 are referred to as intermediate part 35.

As shown in FIG. 1, the lead-out portion 261 includes a terminal portion 261b connectable to a mounting substrate or the like and a connecting portion 261a connecting the winding portion 20 and the terminal portion 261b. As shown in FIG. 1, the connecting portion 261a of the lead-out portion 261 connects the uppermost turn of the winding portion 20 in the Z-axis direction (in the present embodiment, the turn layer 20e shown in FIG. 3) and the terminal portion 261b. As shown in FIG. 3, the terminal portion 261b is partly exposed below a bottom portion 64 of the core 6.

As shown in FIG. 1, the lead-out portion 262 includes a terminal portion 262b (see FIG. 2) connectable to a mounting substrate or the like and a connecting portion 262a connecting the winding portion 20 and the terminal portion 262b. As shown in FIG. 1, the connecting portion 262a of the lead-out portion 262 connects the lowermost turn of the winding portion 20 in the Z-axis direction (in the present embodiment, the turn layer 20a shown in FIG. 3) and the terminal portion 262b (see FIG. 2). As shown in FIG. 3, the terminal portion 262b is partly exposed below the bottom portion 64 of the core 6.

Parts of the terminal portions 261b and 262b exposed below the bottom surface of the core 6 have the above insulating layer 30 removed and are provided with a connectable layer 38 electrically connectable to a wiring substrate or the like. The connectable layer 38 is a portion that is connectable to the wiring substrate or the like. Thus, the connectable layer 38 has solder wettability and plays a role in supporting connection between the terminal portions 261b and 262b and the mounting substrate. The connectable layer 38 has, for example, a plating film. Examples of the plating film include metals (e.g., Sn, Au, Ni, Pt, Ag, and Pd) and their alloys. Methods including sputtering or the like may be used to form the connectable layer 38. The connectable layer 38 has a thickness smaller than that of the terminal portions 261b and 262b. The thickness of the connectable layer 38 may be, for example, 3 to 30 µm.

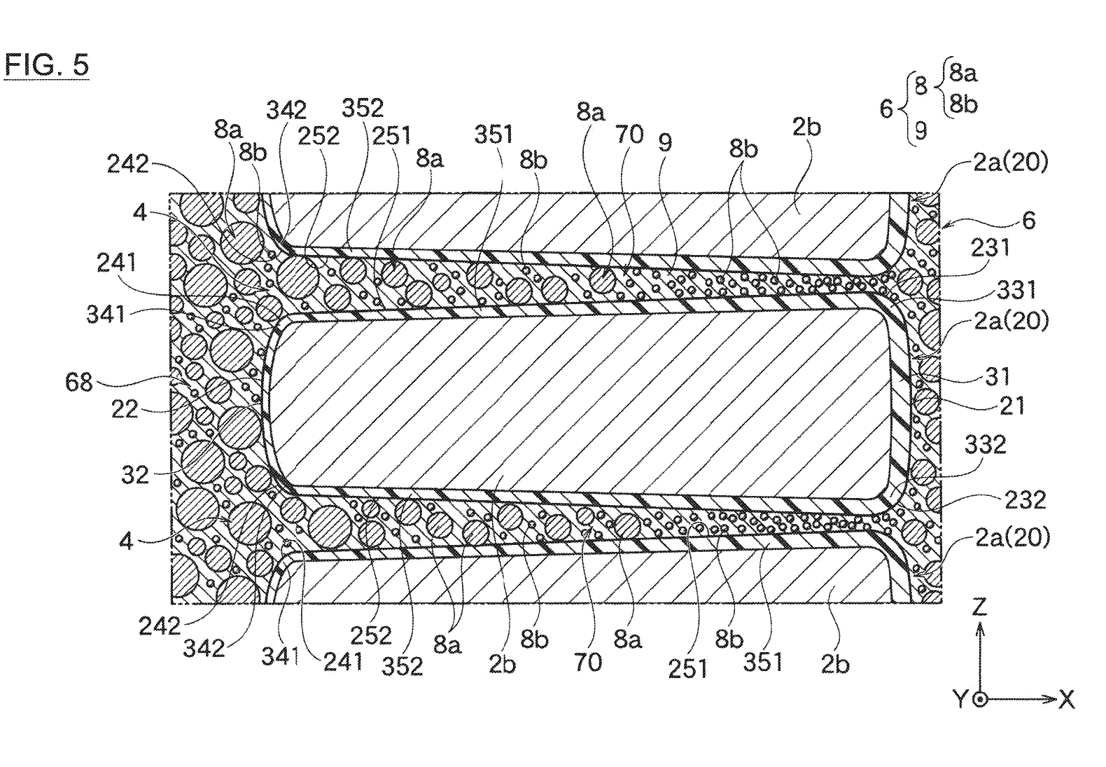

As shown in FIGS. 1 and 2, the core 6 covers the coil 2 except for part of the terminal portions 261b and 262b. As shown in FIG. 5, the core 6 is composed of a material including magnetic particles 8 and a resin 9. Examples of the magnetic particles 8 of the core 6 include ceramic magnetic bodies and metal magnetic bodies.

Examples of ceramic magnetic bodies of the core 6 include ferrites, such as Ni-Zn based ferrites and Mn-Zn based ferrites. Examples of metal magnetic bodies of the core 6 are not limited and include Fe-Ni alloys, Fe-Si alloys, Fe-Si-Cr alloys, Fe-Co alloys, Fe-Si-Al alloys, and amorphous iron.

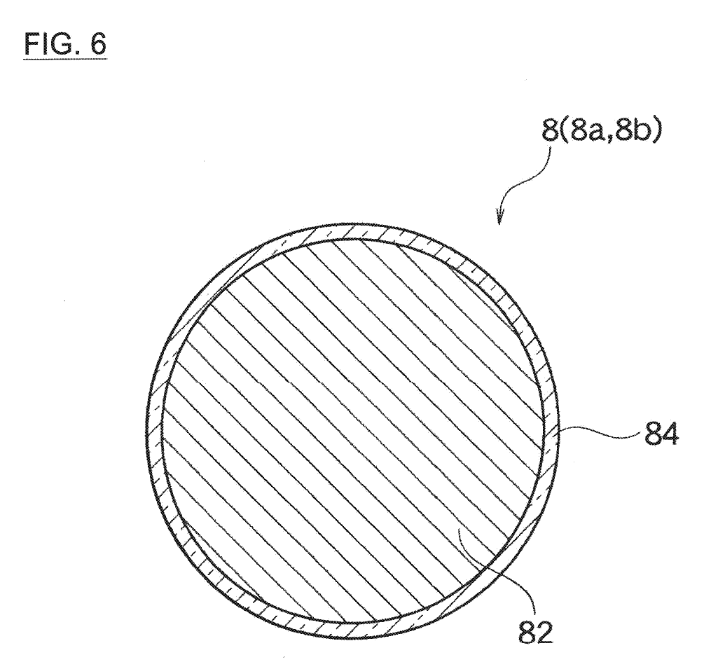

In terms of preventing short circuits and improving product properties, the magnetic particles 8 are insulating and are, for example, insulation coated metal magnetic particles including a metal magnetic body 82 covered with an insulating film 84, as shown in FIG. 6. The insulating film covering a magnetic particle may be an oxide film or an insulation coating film (e.g., glass or resin).

As shown in FIG. 5, the magnetic particles 8 may include first particles 8a and second particles 8b with a smaller average particle size (D50) than that of the first particles 8a. The magnetic particles 8 may include, for example, the first particles 8a with a particle size of 15 µm or more and less than 30 µm and the second particles 8b with a particle size of 3 µm or more and less than 15 µm. The magnetic particles 8 may further include third particles with a smaller particle size than that of the second particles. The third particles may have a particle size of, for example, less than 3 µm.

The resin 9 of the core 6 is not limited. Examples of the resin 9 include an epoxy resin, a phenol resin, a polyester resin, a polyurethane resin, a polyimide resin, other synthetic resins, and other non-magnetic materials.

As shown in FIG. 3, the core 6 includes a columnar portion 62 disposed in the winding portion 20 of the coil, the bottom portion 64 disposed below the winding portion 20, an upper portion 66 covering the winding portion 20 from above, and a side portion 68 covering an outer side of the winding portion 20, in brief. The core 6 may be compaction molded using the above materials; however, in terms of simplifying assembly, the core 6 may be provided by combining a base portion 6a, which includes the columnar portion 62 and the bottom portion 64 molded in advance, and an exterior body 6b, which fills spaces between the coil and the base portion and constitutes portions other than the columnar portion 62 and the bottom portion 64.

The columnar portion 62 may have a height not reaching above the winding portion 20 but may penetrate the winding portion 20 along the winding axis. With the core 6 including the columnar portion 62 inside, the coil device 1 is easily assembled, and a product can be prevented from having a short circuit. The base portion 6a and the exterior body 6b of the core 6 may be molded using the same material or different materials.

As shown in FIG. 3, between the turn layers 20a to 20e is the space 4. A filler 70 of the core 6 is in this space 4. The filler 70 is part of the core 6 and includes the magnetic particles 8 (see FIG. 5). In the space 4 between the intermediate portion 251 of a turn layer and the intermediate portion 252 of the turn layer adjacently above the former turn layer in the Z-axis direction is the filler 70 of the side portion 68 of the core 6. In the core 6, the filler 70 is connected to the side portion 68, which covers the outer side of the winding portion 20, and fills the space 4 inward from the side portion 68. The filler 70 may completely fill the space 4 but may partly leave a blank.

FIG. 5 is an enlarged view of the space 4 between the turn layers 20 shown in FIG. 3 and the core 6 in the space 4. FIG. 5 shows the space 4 between the turn layers 20a and 20b and the space 4 between the turn layers 20b and 20c; however, the same applies to the space between other adjacent turn layers. Hereinafter, the space 4 between the turn layers 20b and 20c is mainly described; however, the description applies to the space between other turn layers.

As shown in FIG. 5, the space 4, which continues inward from the outer side of the winding portion 20, is provided between the turn layers 20b and 20c. That is, the outer corner 241, the intermediate portion 251, and the inner corner 231 of the rectangular wire 2a of the turn layer 20b are away from the outer corner 242, the intermediate portion 252, and the inner corner 232 of the rectangular wire 2a of the turn layer 20c. The space 4 is provided between the intermediate portions 251 and 252 of the turn layers 20b and 20c.

The space 4 may have any size provided that the above magnetic particles 8 can enter the space 4. In terms of filling the space 4 with the magnetic particles 8 well, the size may be, for example, 1 µm or more or at least twice the average particle size (D50) of the small second particles 8b. Alternatively, in terms of reducing the size of a product, the size of the space 4 may be no larger than twice the average particle size (D50) of the large first particles 8a. The space 4 may be provided between at least two adjacent turn layers in pairs. There may be a space 4 not continuing inward from the outer side of the winding portion 20, or adjacent turn layers may be in contact with each other so as partly not to provide the space 4.

As shown in FIG. 5, the space 4 is narrower at an inner side close to the winding axis than at an outer side far from the winding axis. In the filler 70 filling the space 4, the second particles 8b account for a higher percentage in terms of number than that of the first particles 8a. Arrangement such that the second particles 8b account for a higher percentage in terms of number than that of the first particles 8a in the filler 70 enables the filler 70 to efficiently fill the narrow space 4 between adjacent turns of the rectangular wire.

In the filler 70, the percentage of the second particles 8b relative to the first particles 8a in terms of number is higher at the inner side close to the winding axis than at the outer side far from the winding axis. Such a structure enables the filler 70 to easily enter the space 4 between adjacent turns of the rectangular wire 2a continuously from the side portion 68. Additionally, because the insulating magnetic particles 8 and the resin 9 of the filler 70 fill the space 4 between adjacent turns of the rectangular wire 2a, risks of short circuits can be reduced. Also, the magnetic particles 8 of the core 6 easily have a sufficient volume, which can improve product properties.

The number of the magnetic particles 8 in the filler 70 in the space 4 is not limited; however, in terms of reducing risks of short circuits, at least twenty magnetic particles 8 may be in one space 4. The number of the magnetic particles 8 in the filler 70 in the space 4 can be measured by, for example, capturing a sectional image of the space 4 using a scanning electron microscope (SEM) and observing the first particles 8a (particles with a particle size of , for example, 15 µm or more and less than 30 µm) and the second particles 8b (particles with a particle size of, for example, 3 µm or more and less than 15 µm) in the captured space 4. Comparison in the percentage of the second particles 8b relative to the first particles 8a in terms of number in the filler 70 in the space 4 between the outer side far from the winding axis and the inner side close to the winding axis can be made by, for example, observing the numbers of the first particles 8a and the second particles 8b outward from a center of the space 4 and the numbers of the first particles 8a and the second particles 8b inward from the center of the space 4 in a sectional image of the space 4 captured using a scanning electron microscope (SEM).

The coil device 1 of the present embodiment can be manufactured, for example, as follows. First, the base portion 6a, which includes the columnar portion 62 and the bottom portion 64 molded in advance, shown in FIG. 1 is prepared. The rectangular wire 2a whose surface is covered with the above insulating layer 30 is wound edgewise to form the air core coil. In the winding portion 20 of this coil 2, the columnar portion 62 is disposed. The coil 2 is attached to the base portion 6a so that the terminal portion 261b of the lead-out portion 261 and the terminal portion 262b of the lead-out portion 262 are disposed below the bottom portion 64.

Then, the resultant assembly including the coil 2 and the base portion 6a is disposed in a cavity of a predetermined mold. This assembly is arranged so that the terminal portion 261b of the lead-out portion 261 and the terminal portion 262b of the lead-out portion 262 are partly exposed. Around the assembly, the exterior body 6b is insert injection molded. As a constituent material of the exterior body 6b, a material having fluidity at the time of molding is used. A complex magnetic material including a thermoplastic resin or a thermosetting resin as a binder may be used. As described above, the core 6 may also, as a whole, be compaction molded.

As described above, the coil device 1 according to the present embodiment has the space 4, which continues inward from the outer side of the winding portion 20, between adjacent turns of the rectangular wire 2a along the winding axis of the winding portion 20 in a section of the core 6, as shown in FIG. 5. In the space 4 are some of the magnetic particles 8 included in the core 6. In this manner, the space 4 continuing inward from the outer side of the winding portion 20 between adjacent turns of the rectangular wire 2a is provided, and the filler 70 of the core 6 is in this space 4. Thus, the core 6 can have a sufficient volume, which can improve product properties. As described above, the magnetic particles 8 included in the filler 70 are insulating and can thereby reduce risks of short circuits between adjacent turns of the rectangular wire 2a.

The magnetic particles 8 include the first particles 8a and the second particles 8b with a smaller average particle size than that of the first particles 8a. The second particles 8b are disposed in the space 4 so as to account for a higher percentage in terms of number than that of the first particles 8a. Such an arrangement of the particles 8a and 8b with different particle sizes can efficiently fill the space between adjacent turns of the rectangular wire, enabling risks of short circuits to be reduced and product properties to be improved.

The magnetic particles 8 are in the space 4 so that the percentage of the second particles 8b relative to the first particles 8a in terms of number is higher at the inner side close to the winding axis than at the outer side far from the winding axis. Such a structure increases the density of the magnetic particles 8 in the space 4, enabling risks of short circuits to be reduced and product properties to be improved.

The present disclosure is not limited to the above embodiment and can be variously modified to the extent that technical problems do not arise or the scope of the present disclosure is not exceeded.

In the present disclosure, the coil device 1 has an external shape such as a polyhedral shape (e.g., rectangular parallelepiped shape); however, the external shape of the coil device 1 is not limited to a polyhedral shape and may be a columnar shape (e.g., a cylindrical shape or an elliptic cylinder shape) in terms of ensuring effective magnetic flux.

As is understood from the above description, the present specification discloses the following.

### Additional Note 1

A coil device including:

a core including magnetic particles; and

a winding portion including a rectangular wire wound edgewise,

in which

the magnetic particles include insulation coated metal magnetic particles including a metal magnetic body covered with an insulating film,

a space continuing inward from an outer side of the winding portion is provided between adjacent turns of the rectangular wire along a winding axis of the winding portion in a section of the core, and

some of the magnetic particles included in the core are in the space.

### Additional Note 2

The coil device according to additional note 1, in which

the magnetic particles include first particles and second particles with a smaller average particle size than that of the first particles, and

the second particles are disposed in the space so that the second particles account for a higher percentage in terms of number than that of the first particles.

### Additional Note 3

The coil device according to additional note 2, in which the magnetic particles are in the space so that the percentage of the second particles relative to the first particles in terms of number is higher at an inner side close to the winding axis than at an outer side far from the winding axis.

### Additional Note 4

The coil device according to any one of additional notes 1 to 3, in which the space is narrower at an inner side close to the winding axis than at an outer side far from the winding axis.

### Additional Note 5

The coil device according to any one of additional notes 1 to 4, in which an inner end of the rectangular wire is thicker than an outer end of the rectangular wire.

### REFERENCE NUMERALS

1... coil device

11... first outer surface

12... second outer surface

13... third outer surface

14... fourth outer surface

15... fifth outer surface

16... sixth outer surface

2... coil

2a... rectangular wire

2b... conductor

20... winding portion

20a to 20e... turn layer

21... inner end

21a... innermost end

22... outer end

22a... outermost end

23 (231, 232)... inner corner

24 (241, 242)... outer corner

25 (251, 252)... intermediate portion

261, 262... lead-out portion

261a, 262a... connecting portion

261b, 262b... terminal portion

30... insulating layer

31... inner end portion

32... outer end portion

33 (331, 332)... inner corner portion

34 (341, 342)... outer corner portion

35 (351, 352)... intermediate part

38... connectable layer

4... space

6... core

6a... base portion

6b... exterior body

62... columnar portion

64... bottom portion

66... upper portion

68... side portion

70... filler

8... magnetic particle

8a... first particle

8b... second particle

82... metal magnetic body

84... insulating film

9... resin

What is claimed is:

1. A coil device comprising:
a core comprising magnetic particles; and
a winding portion comprising a rectangular wire wound edgewise,
wherein
the magnetic particles comprise insulation coated metal magnetic particles comprising a metal magnetic body covered with an insulating film,
a space continuing inward from an outer side of the winding portion is provided between adjacent turns of the rectangular wire along a winding axis of the winding portion in a section of the core, and
some of the magnetic particles included in the core are in the space.

2. The coil device according to claim 1, wherein
the magnetic particles comprise first particles and second particles with a smaller average particle size than that of the first particles, and
the second particles are disposed in the space so that the second particles account for a higher percentage in terms of number than that of the first particles.

3. The coil device according to claim 2, wherein the magnetic particles are in the space so that the percentage of the second particles relative to the first particles in terms of number is higher at an inner side close to the winding axis than at an outer side far from the winding axis.

4. The coil device according to claim 1, wherein the space is narrower at an inner side close to the winding axis than at an outer side far from the winding axis.

5. The coil device according to claim 1, wherein an inner end of the rectangular wire is thicker than an outer end of the rectangular wire.
